(19) United States
(12) Patent Application Publication
(10) Pub. No.: US 2014/0115841 A1
(43) Pub. Date: May 1, 2014

(54) SECURING DEVICE FOR SEUCRING BICYCLE FRAME TO BICYCLE CARRY RACK

(71) Applicant: KING RACK INDUSTRIAL CO., LTD., TAICHUNG CITY (TW)

(72) Inventor: Chiu-Kuei Wang, Taichung City (TW)

(73) Assignee: KING RACK INDUSTRIAL CO., LTD., TAICHUNG CITY (TW)

(21) Appl. No.: 14/065,417

(22) Filed: Oct. 29, 2013

(30) Foreign Application Priority Data
Oct. 31, 2012 (TW) 101221089

(51) Int. Cl. B60P 7/08; A44B 11/12

(52) U.S. Cl. CPC B60P 7/0823; A44B 11/125
USPC 24/68 CD

(57) ABSTRACT

A securing device includes a base connected with a bicycle carry rack. A belt unit includes a body and a locking member. A belt is connected to the body and extends through a path in the body. The locking member is pivotably connected to the body. The locking member is a cam. A fixed part is connected to the body and an opening is defined between the fixed part and the locking member. The first end of the belt is fixed to the body and the second end of the belt extends through the path and the passage, and entering through a through hole in the body and then goes out from the opening so as to clamp the bicycle frame between the base and the body. By pivoting the locking member, the opening becomes larger to release the belt.

### FIELD OF THE INVENTION

The present invention relates to a securing device, and more particularly, to a securing device for securing bicycle frame to a bicycle carry rack.

### BACKGROUND OF THE INVENTION

The conventional bicycle carry racks are designed to be connected to the rear end of the car and is able to carry bicycles with the car. There are two types of carry rack available, one of which includes grooves in which the bicycle frames are secured, and the other type is a trailer which is moved with the car and the bicycles are located in the trailer. The conventional bicycle carry rack has a connection member so as to be connected with the hitch, or the bicycle carry rack directly attached to the rear end of the car by hooks and tightening strips. There are many tightening strips are used to secure the bicycle to the carry rack, most of the tightening strips are made by plastic which has a head on one end and the other end of the tightening strip extends through the head. Multiple teeth are formed on the tightening strip and one of the teeth is engaged with a locking tooth in the head so as to tighten the bicycle frame, such as the top tube, to the carry rack.

However, the tightening strip is mounted to outside of the bicycle frame and most of the bicycle frames and the carry rack are composed by round tubes, so that the contact area between the bicycle frames and the carry rack is small. Therefore, the bicycles on the carry rack easily shake when the car moves along a rugged road. The plastic-made tightening strips do not have proper flexibility to match the curvatures of the bicycle frames and the carry rack. This causes the bicycles to be loosened during transportation.

When dismounting the bicycles from the carry rack, the plastic-made tightening strips have to be cut, and this causes waste and the user has to prepare scissors or knifes. Besides, when the bicycles are secured to the carry rack again, new tightening strips are required.

The present invention intends to provide a securing device for positioning a bicycle frame on the bicycle carry rack so as to improve the shortcomings mentioned above.

### SUMMARY OF THE INVENTION

The present invention relates to a securing device and comprises a base having an elongate installation hole so as to be connected with a bicycle carry rack. The base has a contact side and a belt side on two sides thereof. The belt side has a passage defined therethrough. A belt unit has a locking unit and a belt, wherein the locking unit has a body and a locking member. The belt is connected to the body and the locking member is able to lock the belt. The body has a path defined longitudinally therethrough. The body has an inside and an outside, wherein the inside of the body has a curved contact face. The locking member is pivotably connected to one end of the contact face. The locking member has a head on one end thereof and the head has a pin extending eccentrically therethrough. The head has a short side and a long side, wherein the distance from the short side to the pin is shorter than the distance from the long side to the pin. A fixed part is connected to the body and located opposite to the contact face. An opening is defined between the fixed part and the head. The opening communicates with the contact face. A through hole is defined in the body and communicates with the opening.

The first end of the belt is fixed to the body. The second end of the belt extends through the path and the passage of the base, and enters through the through hole and goes out from the opening. The locking member is pivoted to adjust the size of the opening by shifting the long side and the short side relative to the opening. When the long side contacts the belt, the opening is narrower and the contact face of the body contacts the bicycle frame.

The securing action of the present invention does not need any tool, the belt securely position the bicycle frame between the contact face of the body and the belt. The locking member is then pivoted to press and secure the belt. The locking member is a cam which provides reliable securing feature to the belt.

The elongate and curved contact face of the body contacts the bicycle frame and the length of the belt can also be adjusted, so that the securing device of the present invention can secure the bicycle frames of different sizes. The contact side and the contact face provide securing features from two directions, and the belt is locked by the locking member, so that the bicycle frame is well secured.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the securing device of the present invention;

FIG. 2 is another perspective view to show the securing device of the present invention;

FIG. 3 is an exploded view to show the securing device of the present invention;

FIG. 4 shows the connection of the bicycle carry rack, the bicycle frame and the securing device of the present invention;

FIG. 5 is a cross sectional view to show that the securing device of the present invention is used to secure the bicycle frame with smaller size;

FIG. 6 is a cross sectional view to show that the securing device of the present invention is used to secure the bicycle frame with larger size;

FIG. 7 shows that the securing device of the present invention is cooperated with a bicycle carry rack.

### DETAILED DESCRIPTION OF THE PREFERRED EMBODIMENT

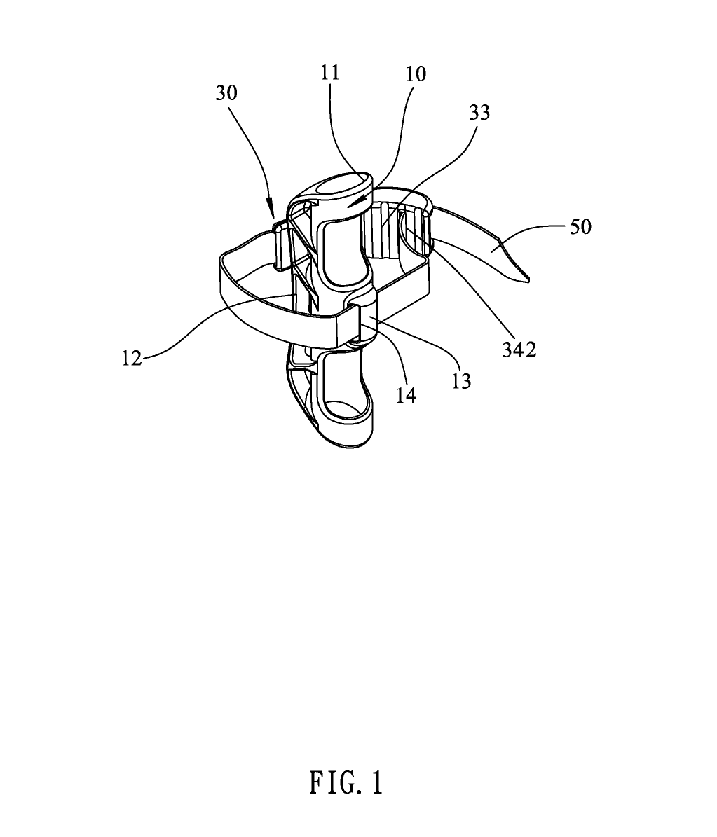

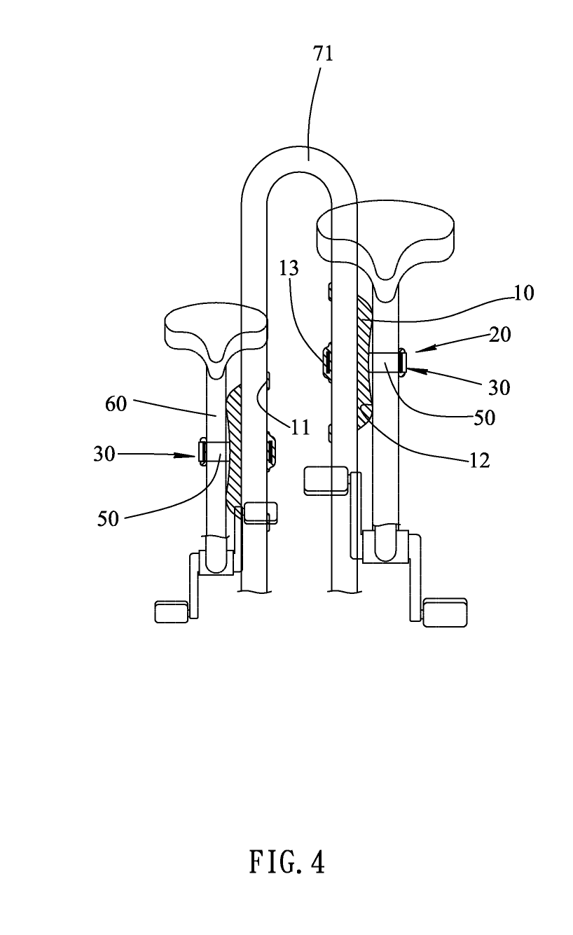

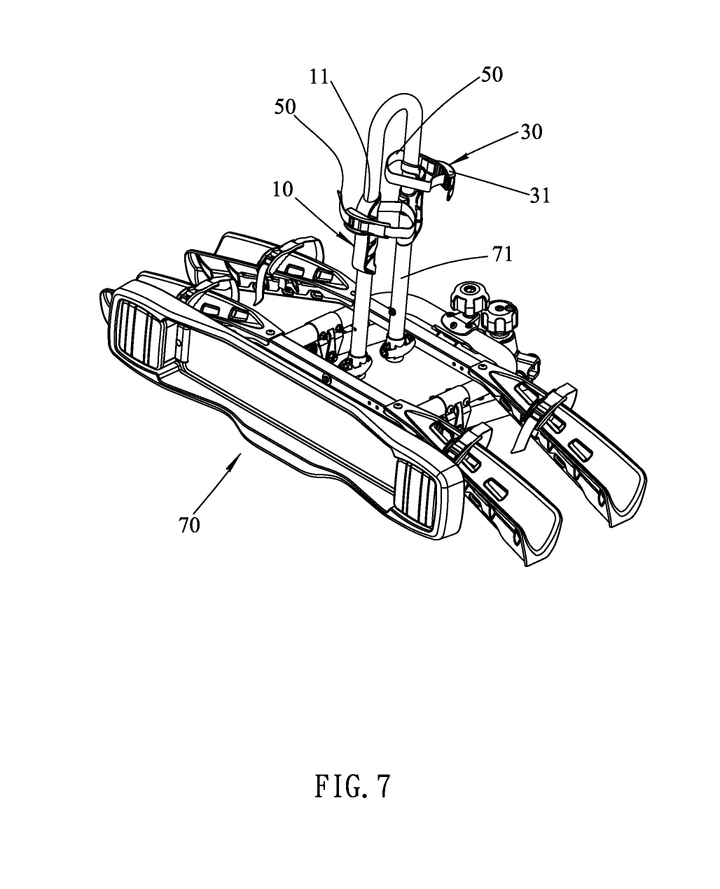

Referring to FIGS. 1 to 3, the securing device of the present invention comprises a base 10 and a belt unit 20. The base 10 is an elongate member and has an elongate installation hole 11 defined longitudinally therethrough so that the upright tube 71 of the bicycle carry rack 70 extends through the installation hole 11 such that the base 10 is connected with the bicycle carry rack 70 as shown In FIGS. 4 and 7. The base 10 has a contact side 12 and a belt side 13 on two sides thereof. The belt side 13 has a passage 14 defined therethrough.

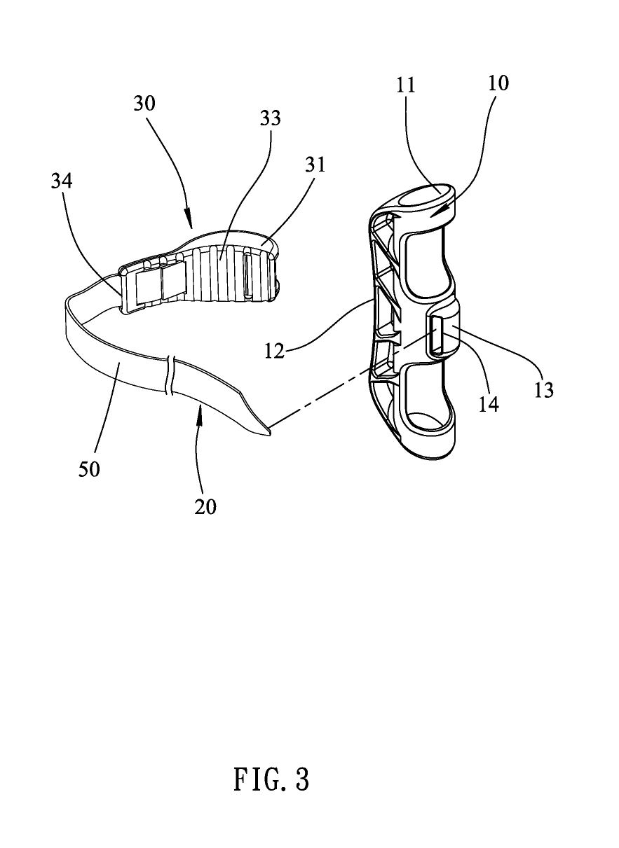

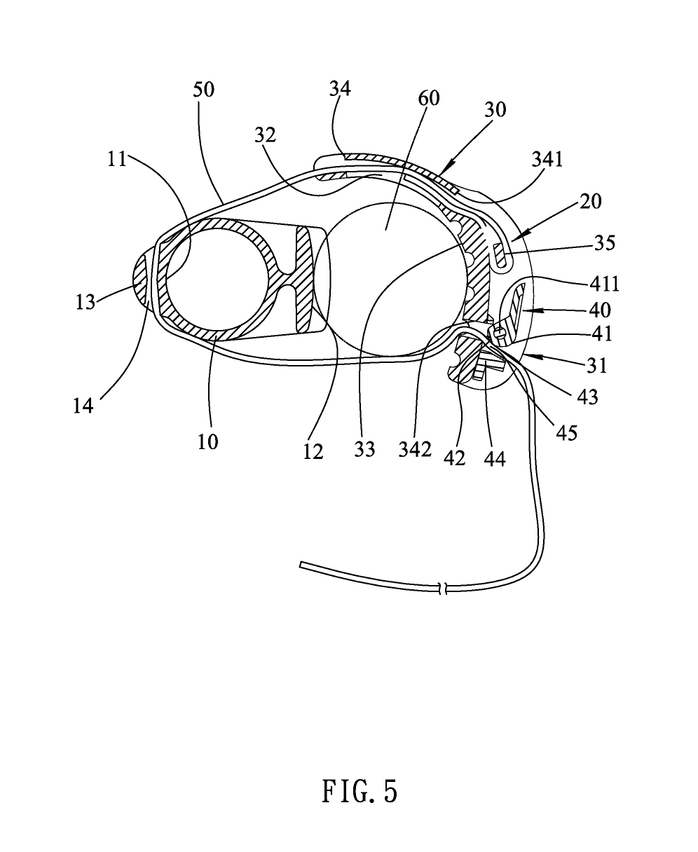

The belt unit 20 comprises a locking unit 30 and a belt 50. The locking unit 30 has a rectangular body 31 and a locking member 40 which is used to secure the belt 50. The body 31 has a path 23 defined longitudinally therethrough as shown in FIGS. 3 and 5, and the body 31 has an inside and an outside, wherein the path 23 is located between the inside and the outside. The inside of the body 31 has a curved contact face 33 which is an anti-slip face.

The body 31 of the locking unit 30 comprises a first hole 34, an elongate second hole 341 and a through hole 342 in sequence. A fixed member 35 is located beside the second hole 341 and the locking member 40 is located beside the fixed member 35.

The locking member 40 is pivotably connected to one end of the contact face 33 and has a head 41 on one end thereof. The head 41 has a pin 411 extending eccentrically therethrough so that the locking member 40 is a cam. The head 41 has a short side 42 and a long side 43. The distance from the short side 42 to the pin 411 is shorter than the distance from the long side 43 to the pin 411. A fixed part 44 is connected to the body 31 and located opposite to the contact face 33. An opening 45 is defined between the fixed part 44 and the head 41. The opening 45 communicates with the contact face 33, the through hole 342 defined in the body 31 and communicates with the opening 45.

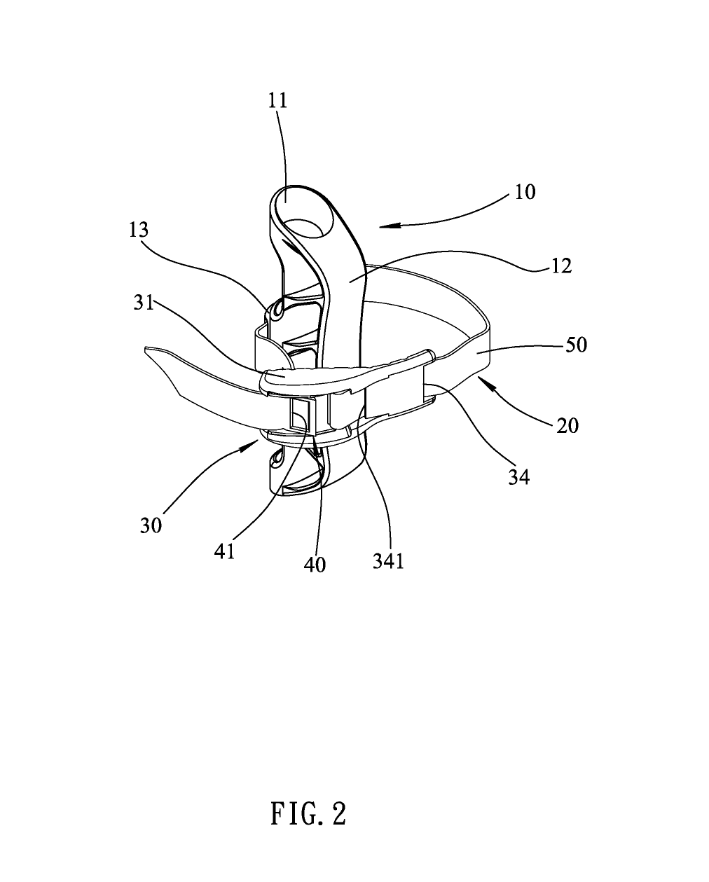

The first end of the belt 50 is fixed to the fixed member 35 and the second end of the belt 50 extends through the path 32 and the first hole 34, the second end of the belt 50 then extends through the passage 14 of the base 10 and enters into the through hole 342 and extends through the opening 45 of the body 31. By this arrangement, the belt 50 goes along the outside of the base 10 as shown in FIGS. 1 and 2.

As shown in FIGS. 4 and 7, the upright tube 71 of the bicycle carry rack 70 extends and secured to the installation hole 11 so as to connect the base 10 to the bicycle carry rack 70. When securing a bicycle to the bicycle carry rack 70, as shown in FIGS. 2, 5 and 6, the seat tube 60 is in contact with the contact side 12 of the base 10, and the user pulls the belt 50 to contact the contact face 33 against the other portion of the seat tube 60. In other words, the seat tube 60 is clamped in two directions by the contact side 12 of the base 10 and the contact face 33 of the body 31.

After the belt 50 is tightened, the locking member 40 is pivoted about the pin 411, and the long side 43 is moved toward the fixed part 44, so that the opening 45 is narrower and is smaller than the thickness of the belt 50. The belt 50 is then clamped by the long side 43 and the fixed part 44. Therefore, the seat tube 60 is well secured.

When the user wants to remove the bicycle from the bicycle carry rack 70, the locking member 40 is pivoted about the pin 411 in opposite direction, and the short side 42 is moved toward the fixed part 44, so that the opening 45 becomes larger so that the belt 50 can be moved freely in the path 32, the through hole 342 and the opening 45. This enlarges the area that the belt 50 clamps the seat tube 60, or the belt 50 can be pulled from the locking unit 30 to allow the user to remove the bicycle from the bicycle carry rack 70.

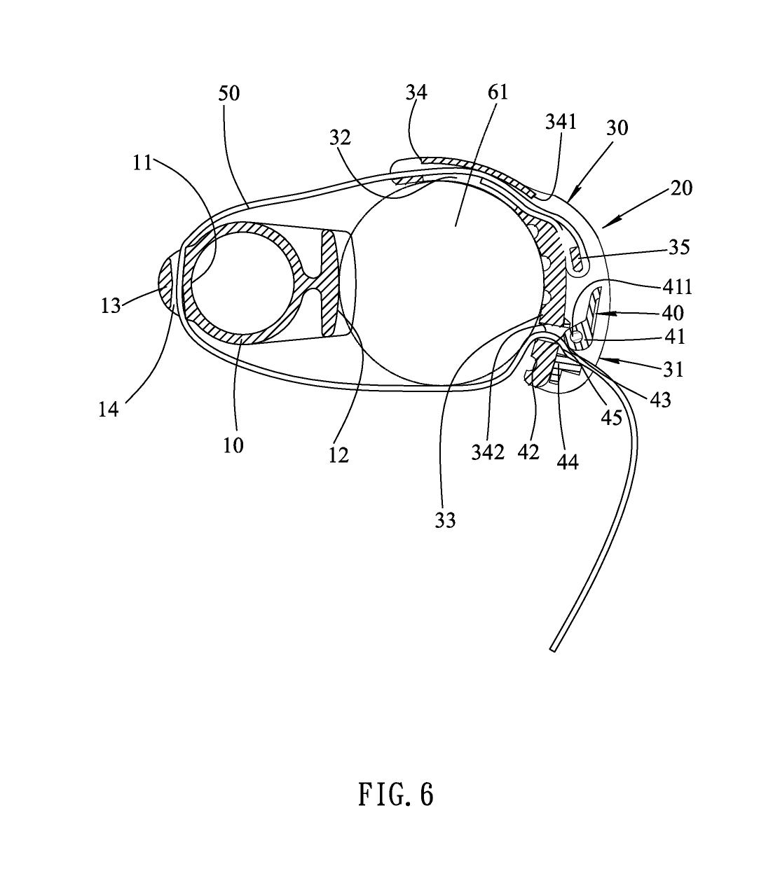

FIG. 6 shows that a larger size of the seat tube 601 is clamped between the contact side 12 of the base 10 and the contact face 33 of the body 31. Because the contact face 33 is a curved face so that the larger size of the seat tube 601 is clamped at sufficient contact area. By cooperation with the locking unit 30 and the belt 50, the seat tube 601 is well secured.

While we have shown and described the embodiment in accordance with the present invention, it should be clear to those skilled in the art that further embodiments may be made without departing from the scope of the present invention.

What is claimed is:

1. A securing device comprising:
a base having an elongate installation hole which is adapted to be connected with a bicycle carry rack, the base having a contact side and a belt side on two sides thereof, the belt side having a passage defined therethrough;
a belt unit having a locking unit and a belt, the locking unit having a body and a locking member, the belt connected to the body and the locking member locking the belt, the body having a path defined longitudinally therethrough, the body having an inside and an outside, the inside of the body having a curved contact face, the locking member pivotably connected to an end of the contact face, the locking member having a head on one end thereof, the head having a pin extending eccentrically therethrough, the head having a short side and a long side, a distance from the short side to the pin being shorter than a distance from the long side to the pin, a fixed part is connected to the body and located opposite to the contact face, an opening defined between the fixed part and the head, the opening communicating with the contact face, a through hole defined in the body and communicating with the opening, and
a first end of the belt being fixed to the body, a second end of the belt extending through the path and the passage of the base, and entering through the through hole and going out from the opening, the locking member being pivoted to adjust a size of the opening by shifting the long side and the short side relative to the opening, when the long side contacts the belt, the opening is narrower and the contact face of the body is adapted to contact a bicycle frame.

2. The securing device as claimed in claim 1, wherein the body of the locking unit comprises a first hole, an elongate second hole and the through hole in sequence, a fixed member is located beside the second hole, the locking member is located beside the fixed member, the first end of the belt is fixed to the fixed member and the second end of the belt extends through the path and the first hole, the second end of the belt then extends through the passage of the base and enters into the through hole and extends through the opening of the body.
